(19) United States
(12) Patent Application Publication
(10) Pub. No.: US 2017/0191581 A1
(43) Pub. Date: Jul. 6, 2017

(54) ONE ACTUATOR WITH TWO OR MORE VALVE-DRIVE

(71) Applicant: Hanon Systems, Daejeon (KR)

(72) Inventors: Mirko Brezowsky, Bergheim (DE); Carsten Ohrem, Bergheim (DE); Peter Diehl, Köln (DE); Stojan Cucuz, Köln (DE)

(21) Appl. No.: 15/399,790

(22) Filed: Jan. 6, 2017

(30) Foreign Application Priority Data
Jan. 6, 2016 (DE) 102016100193.7

(51) Int. Cl. F16K 31/524; F02M 35/10; F01N 13/08; F02M 26/53

(52) U.S. Cl. CPC F16K 31/52408; F02M 26/53; F02M 35/10255; F01N 13/08; F01N 2390/02

(57) ABSTRACT

An assembly and method for operating actuators, the assembly including a control device with at least a first control device part and a second control device part, wherein the first control device part is connected at least indirectly to a first actuator and the second control device part is connected at least indirectly to a second actuator. The method including a control device provided with a first control device part and a second control device part, wherein the first control device part controls a first actuator and the second control device part controls a second actuator simultaneously, wherein control is accomplished wherein at least a first condition, in which the first and second actuators are closed simultaneously, and a second condition, in which the first actuator is closed and the second actuator is opened or the first actuator is opened and the second actuator is closed, can be controlled.

### CROSS-REFERENCE TO RELATED PATENT APPLICATIONS

This patent application claims priority to German Pat. Appl. No. 10 2016 100 193.7 filed Jan. 6, 2016, the disclosure of which is hereby incorporated herein by reference in its entirety.

### FIELD OF THE INVENTION

The invention relates to an assembly for operating actuators, comprising a drive system for driving a control device that is connected to the drive system, the control device being connected at least indirectly to an actuator. The invention also relates to a method for operating actuators, wherein a control device is provided, which is connected to a drive system and which, driven by the drive system, controls an actuator. Such assemblies and methods for operating actuators are utilized in many technical fields, for example plant and machinery construction and vehicle construction. Although the following description refers frequently to a utilization of the invention in vehicle construction, this is not intended to restrict the application of the invention to this field.

### BACKGROUND OF THE INVENTION

For example, in the field of vehicle construction, functions of an internal combustion engine and other component assemblies are often controlled by means of valves and/or shutters. These valves and shutters represent the actuators in a control system or a control loop. Since the present invention can be used in both a control system and a regulation system, no differentiation will be made between the terms used in control engineering of controlling and of regulating an actuator such as a valve or a shutter. The general term of an actuator operation is intended to encompass applications in the field of regulation as well as applications in field of control.

For controlling or regulating various functions, it is common to connect a valve or a shutter to a drive system, which is also described as an actuator. Such actuators convert, for example, an electric input value such as a control voltage into a mechanical movement such as rotation. It is also common to position a gear unit or a similar mechanical component assembly between the valve or the shutter and the drive system, by means of which gear unit, for example, a rotational movement generated by the drive system is adjusted to a rotation with a lower rotational speed or to a linear movement, by means of which the valve or the shutter can be controlled advantageously.

For compliance with legally prescribed standards for the emission of exhaust gases from an internal combustion engine, e.g. nitrogen oxides (NOx), volatile organic substances from hydrocarbons (HC), soot particles and carbon dioxide gases (CO₂), it is known to remove exhaust gases from the exhaust gas path outside of the internal combustion engine in order to cool them and return them to the combustion process. Especially in these fields of exhaust gas recirculation (EGR), such valves and shutters, also called exhaust gas recirculation and bypass valves, are utilized.

In the field of exhaust gas recirculation systems, exhaust gas recirculation systems for diesel engines as well as for gasoline engines are known. Within these systems, differentiation is made between so called high pressure exhaust gas recirculation systems and low pressure exhaust gas recirculation systems and between a removal before exhaust gas aftertreatment, e.g. through a catalytic converter or a diesel particle filter or diesel soot particle filter (DPF), and a removal after this exhaust gas aftertreatment.

It is also known to install both high pressure and low pressure systems in a vehicle, e.g. in a turbo charged internal combustion engine.

One such exhaust gas recirculation system can encompass components such as an exhaust gas recirculation radiator, an exhaust gas recirculation valve, embodied e.g. as a conical valve, a bypass path, and a bypass valve, embodied as a shutter or a conical valve with an electric or pneumatic drive system, for example.

From the prior art, component assemblies are also known, which e.g. comprise a valve and a shutter with their controlling units. For instance, in an exhaust gas recirculation module e.g. an exhaust gas recirculation valve with a electric drive system and a second valve or a bypass shutter with a pneumatic drive system can be positioned.

Alternatively, exhaust gas recirculation modules are known that include only one valve but with two different functions. In that way, controlled by means of an input side valve, such exhaust gas recirculation modules can switch between a bypass path function and an alternative cooling of the exhaust gas flow in a cooling path. In this way, both a cooling function and alternatively a bypass function are implemented in a single module.

According to the known prior art, assemblies for operating actuators are designed such that in each case one drive system activates one actuator, with either a valve or a shutter being deployed as actuators.

In a turbocharged internal combustion engine, according to the prior art, in an exhaust gas recirculation system e.g. the following component assemblies may be used:
high pressure exhaust gas recirculation radiator
high pressure exhaust gas recirculation valve (with actuator)
high pressure bypass path
high pressure bypass valve (with actuator)
low pressure exhaust gas recirculation radiator
low pressure exhaust gas recirculation valve (with actuator)
low pressure bypass path
low pressure bypass valve (with actuator)
waste gate valve (with actuator)
diverter valve (with actuator)

In this way, for these application options, six different components result, each of which requires installation space and adds weight and cost to the vehicle.

The six components embodied as valves also each require, for example, an electric drive system for controlling the valve. These component assemblies result in considerable complexity, space and cost.

From the prior art, a solution is also known in which on an axis that is driven by an actuator, two shutters are attached, the shutters being assigned to different sections of a branching gas channel. In this embodiment it is possible to lock the first branch of the channel completely with the first shutter, while through the second shutter the second branch is completely open, and vice versa. The secure disposition of both shutters on a rotational axis prevents a condition from occurring in which both shutters are closed or both shutters are open. Thus the use of this assembly is limited to cases in which, for example, a flowing medium is to be distributed between two paths.

The object of the invention is to specify an assembly and a method for operating actuators, with which the complexity, the number and the weight of the components as well as the amount of space required and the costs are reduced.

### SUMMARY OF THE INVENTION

The object is achieved by an item having the features as shown and described herein.

The invention proposes using one drive system to control two or more actuators such as valves or shutters simultaneously or independently of one another. In this, a control device that is operated by a drive system is deployed, which control device has two control device parts, with the first control device part being designated for operating the first actuator and the second control device part being designated for operating the second actuator.

It is foreseen that each of the control device parts is formed by a cam disc, a cam or a section of a cam track. The control device parts may be designed as the same or different from one another in terms of their form or their cam profile or track profile. Cam and track profiles that are different from one another enable actuators that are controlled by means of the control device parts to be controlled or regulated differently. As actuators, for example, at least two valves, at least two shutters or at least one valve and at least one shutter can be used, and can each be operated simultaneously or independently from one another.

If a cam track is used, it is provided that said track has at least two sections, which form the first and the second control device part. Within each section at least one elevation is provided on the track, in order to achieve an actuation or deflection of a corresponding actuator. An elevation of this type represents a deviation from a linear track profile. In this embodiment each control device part controls a corresponding actuator, so that two actuators can be operated by means of two sections on a cam track.

Such a cam track can extend along straight lines or along an imaginary circular path. In an alternative embodiment, it is foreseen that one or more actuators are controlled by means of one slot. This slot can be incorporated in a longitudinally or circularly extending surface of a body. Within the course of the slot at least two sections are formed as well, which are assigned to each of at least two control device parts.

It is also foreseen that the slots have in every section so called deflections, which represent deviations from a rectilinear slot path and which can appear in both directions transversely to the longitudinal path of the slot. By scanning the path of the slot with an appropriate scanning means, such as a pin, and transmitting the position or deflection of the scanning device to the actuator, it can be controlled or regulated correspondingly. In most cases the body in which the slot is produced is then moved, depending on the design of the slot, in a longitudinal or rotational movement by means of a drive system.

Through the present invention, various actuators, for example valves or shutters and others, can be controlled or regulated. It is foreseen for at least two valves or two shutters to be operated at the same time or independently of one another by means of one drive system. In a particular embodiment, at least one valve and at least one shutter are operated at the same time or independently of one another by means of one drive system. Such valves or shutters may be deployed in particular in the field of exhaust gas aftertreatment in an internal combustion engine.

It is beneficial to position a gear unit between a drive system and the first and the second control device parts. This allows a relatively high rotational speed of the drive system to be converted to a lower rotational speed at the output of the gear unit. At the output of the gear unit, a shaft can be installed which transmits the rotation to the control device parts. This reduction in the rotational speed leads to an improvement in the accuracy of operation of the actuators.

At the output of one such gear unit or in its place, a device for converting a rotational movement into a longitudinal movement may also be positioned. In this case, the control device parts are not rotated but are instead shifted within a limited adjustment range along an imaginary line.

In one embodiment, it is foreseen that a redirection device is positioned between a control device part and the actuator that is to be controlled or regulated. This redirection device can change the direction of movement that can be generated by a control device part and adjust it to the direction of movement that is required for the actuator. In one example, the redirection device is a rocker with a pivot point that is positioned, for example, at the center of the rocker. Alternatively, this pivot point may be positioned eccentrically; the rocker then becomes a lever that is capable of transmitting greater force.

The object is achieved by a method having the features as shown and described herein.

By utilization of the invention, it is possible that when controlling e.g. two valves or shutters, at least a first condition, in which both valves or shutters are closed, and a second condition, in which a first valve or a first shutter is open while a second valve or a second shutter is closed, and vice versa, can be controlled.

Thus each valve or each shutter can be opened independently of a second valve or a second shutter, even though it is at least indirectly connected to this mutually via a control device with a drive system. Through this possibility of individually controlling the valves or the shutters, the number of required drive systems can be reduced. The costs, the production expenditure, the installation space required and the weight of the component assemblies are also reduced through this reduction in the number of required drive systems.

It is beneficial for the control system to be designed such that a third condition, in which both valves or shutters are at least partially opened, is also possible.

With this option, the scope of control and regulation of the inventive assembly for operating actuators, and therefore its potential uses, are expanded.

On top of that, it is foreseen that the first and second control device parts are designed such that within the third condition, the degree of the opening or closing of the valves or shutters can vary. In this case, when the first valve or the first shutter is opened further, the second valve or the second shutter closed further, and vice versa.

Alternatively, the control device parts may also be designed in such a way that in this third condition, a control or regulating region can be established in which a first valve is controlled so as to open or close from its at least partially opened condition, while the second valve remains in its at least partially opened condition.

This leads to a significant expansion of the controlling and regulation possibilities that are feasible by means of the present invention, thus expanding its utilization possibilities.

One of many possible uses of the invention involves, for example, an engine developer applying the described system, thereby opening up the possibility of presenting various functions with one compact system and incorporating this into his engine development. This enables him to adjust engine characteristic maps better with respect to EGR and to operate the engine more efficiently in terms of consumption and exhaust gas emissions. For cost reasons, either a high pressure or a low pressure system is often used. The reduction of costs with the aid of this system can lead to an introduction of the above mentioned potential in the engine development into the series, thereby making the mass of engines non-polluting.

### BRIEF DESCRIPTION OF THE DRAWINGS

Further details, features and advantages of embodiments of the invention will be apparent from the following description of embodiments, with reference to the corresponding drawings. Shown are:

FIG. 1: an assembly known from the prior art for operating an actuator,

FIG. 2: a cross-sectional representation of a portion of an exhaust gas recirculation module from the prior art with two integrated functions,

FIGS. 3A to 3C: several views illustrating the principle of a first example of an assembly according to the invention for operating actuators,

FIG. 4: a graphic illustration of the process of the stroke functions of the actuator of the assembly of FIGS. 3A-3C, as a function of the rotational angle,

FIG. 5: a table listing of the conditions of the actuators of FIGS. 3A-3C,

FIG. 6: a second example of an assembly according to the invention for operating actuators,

FIG. 7: a graphic illustration of the process of the stroke function of actuators of the assembly of FIG. 6, as a function of the deflection of the linear drive system,

FIG. 8: a further embodiment of an assembly according to the invention for operating actuators,

FIGS. 9A and 9B: embodiments of the control device as a cam track in two possible variants, and

FIG. 10: an exemplary overview of the utilization possibilities of an assembly according to the invention for operating actuators in the field of a internal combustion engine.

### DETAILED DESCRIPTION OF EMBODIMENTS

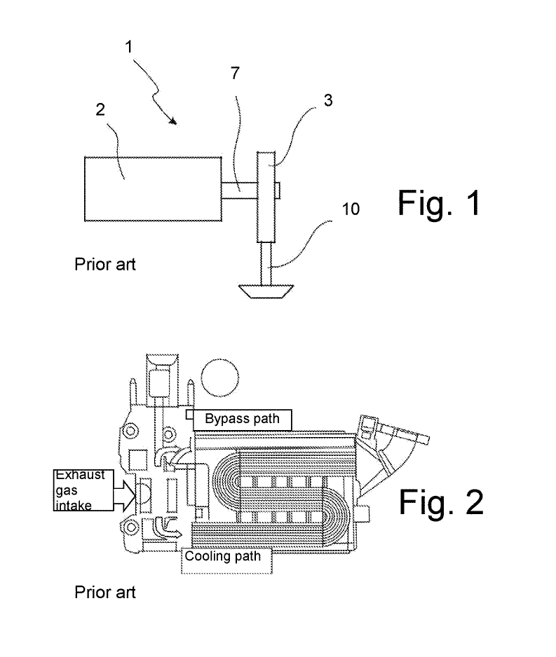

In FIG. 1, an assembly 1 known from the prior art for operating actuators is shown. The assembly 1 consists of a drive system 2, that drives a shaft 7. On the shaft 7, a control device 3 is positioned, which operates an actuator 10. The actuator 10 is shown as a valve in the diagram of the FIG. 1, however the illustration of a valve seat which, together with the valve, is provided for sealing a combustion chamber, a flow channel or similar arrangements, in which a flow of streaming fluid is to be regulated, has been omitted.

The control device 3 is embodied in the example as a cam disc, which during the rotating of the valve 10, according to its curve profile, correspondingly gets open and closed. The valve 10 can thus be controlled through an application of an appropriate control voltage to the drive system 2, which is embodied as an electric motor. In place of the valve 10 that is controlled by the control device 3, a shutter may also be provided as the actuator 10.

According to this concept, it is necessary to foresee a separate drive system 2 for every actuator 10.

In FIG. 2, a cross-sectional representation of a portion of an exhaust gas recirculation module from the prior art with two integrated functions is shown. This assembly enables the incoming exhaust gas to be conducted either through a so called bypass path to the exit directly or through a correspondingly created cooling path to the exit of the module, by means of a valve 10 positioned on the input side. It is provided that the incoming exhaust gas is cooled as is flows through the cooling path and leaves the module at a reduced temperature.

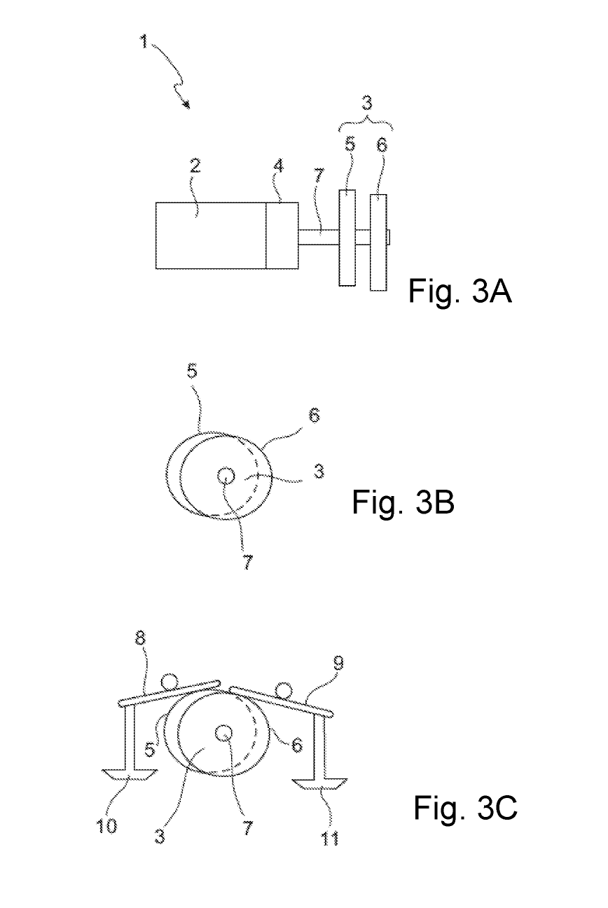

In FIGS. 3A, 3B and 3C, a first example of an assembly according to the invention for operating actuators is shown in various views. The FIGS. 3A, 3B and 3C are only concept displays of the assembly 1. They are therefore limited to the essential elements of the assembly and are not true to scale.

FIG. 3A shows a drive system 2, which can be an electric motor, for example, and is connected via a shaft 7 to the control device 3. According to the invention, the control device 3 consists at least of a first control device part 5 and of a second control device part 6. In the example of FIG. 3A, both control device parts 5, 6 are formed as cam discs, which may have the same or different curve profiles. It is possible optionally that between the drive system 2 and the two control devices 5, 6 a gear unit 4 is positioned for a rotational speed adjustment.

FIG. 3B shows the above-described assembly 1 in a view from the right side. The control device 3 is shown, positioned on the shaft 7 with both control device parts 5 and 6. The embodiments of the two cam discs are exemplary and may be correspondingly adjusted by a person skilled in the art according to a particular control purpose to be complied with.

In the third partial illustration of FIG. 3C, a view is chosen from the right side if the assembly 1 of FIG. 3A as well. In addition to the above described components, a first redirection device 8, a second redirection device 9, each with their central pivot points, along with a first actuator 10 and a second actuator 11 are shown. The actuators 10, 11 are valves, which affect a flow of a streaming fluid, such as a gas. In FIG. 1, the channels for the streaming fluid and valve seats for each are not shown.

When the drive system 2 is actuated by means of an electric control voltage, the drive system 2 rotates the shaft 7, and the rotational movement is geared down by means of the gear unit 4. The control device parts 5, 6, arranged on the shaft 7, are rotated in a direction defined by the control voltage. This rotational movement leads, via the respective profile of the cam discs 5, 6, to a deflection of the redirection devices 8, 9, which is transmitted to the valves 10, 11. In such way, it is possible to operate two valves 10, 11 or to change the positions thereof using one drive system 2.

In an advantageous embodiment, the control device 3 can also have three or more control device parts, and can thus control three or more valves, for example. In place of the controlled valves, a plurality of shutters may also be actuated by the invention as well.

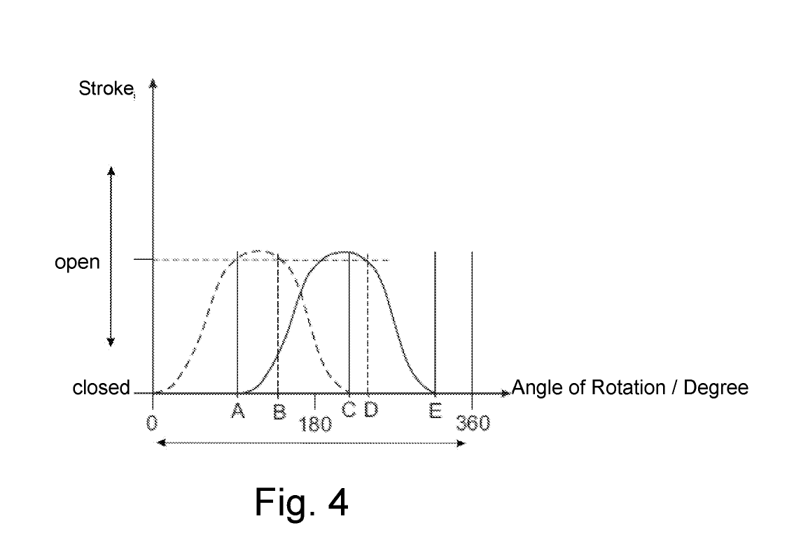

FIG. 4 shows a graphic illustration of the curves for the stroke functions of the cam discs 5, 6 of the assembly 1 according to FIGS. 3A to 3C, as a function of the rotational angle of the shaft 7, in degrees. In the example, the stroke curve indicated by the left bell curve is that of cam disc 5 and controls the first valve 10, whereas the stroke curve indicated by the right bell curve is that of the cam disc 6, which controls the second valve 11. The degree figures indicated in the description for rotational angles are exemplary and may obviously be changed by a person skilled in the art and thus adjusted as needed, regardless of what field of technology the invention is being used in.

It is clear that, at a rotational angle of 0 degrees, both valves 10, 11 are not actuated, and in this example should be closed. Alternatively, the valves 10, 11 may also be opened at that rotational angle, if this is beneficial for the specific use. If the shaft 7 rotates in such a way that the rotational angle increases, the adjustment of the stroke curve, which is caused by the external geometry of the first cam disc 5, increases, thereby controlling the first valve 10 to open.

In the region between 0 degrees and point A, for example at around 90 degree, as shown in FIG. 4, the first valve 10 is progressively opened by the first cam disc 5, while the second valve 11 remains completely closed. In this region, the second cam disc 6 is formed such that no adjustment of the second valve 11 occurs. From the point A, at which the first valve 10 is virtually completely open, as the rotational continues to increase, the second valve 11, controlled by the second cam disk 6, begins to open. In the region between the points A and B, it is assumed that the first valve 10 is completely open.

Approximately from the point indicated at B, the closing process of the first valve 10 starts, while as the rotational angle continues to increase, the second valve 11 opens further, until it is virtually completely opened at a rotational angle of around 190 degrees. At point C, a condition is achieved in which the first valve 10 is completely closed and the second valve 11 maximally open. From the point D, the second valve 11 begins its closing process, which extends up to the point E. In the region between the point E and 360 degrees, neither of valves 10, 11 is controlled by its cam disc 5 or 6, and the valves 10, 11 remain closed.

Through a suitable controlling of the drive system 2, the above described process can be run through, starting from a rotational angle of 0 to 360 degrees. Through an alternative actuation of the drive system 2, it is also possible to run through the actuation process of the valves 10, 11 in the opposite direction from 360 degrees toward 0 degrees.

It is also foreseen to stop the drive system 2 at any point and to reverse its rotating direction. By means of a suitable central controlling unit, not shown, it is possible, for example in dependence on measured values from an appropriate sensor, to implement a valve control as needed for two or more valves or shutters. The innovation can thus be used for controlling an internal combustion engine for example in the field of exhaust gas aftertreatment and/or exhaust gas recirculation.

With the assembly according to the invention, a first condition can be controlled in which both actuators 10, 11 are closed. This first condition occurs at 0 degrees or in the region between point E and 360 degrees.

A second condition may also be controlled, in which the first actuator 10 is closed the second actuator 11 is open or the first actuator 10 is open and the second actuator 11 is closed. This condition occurs, for example, at point A or C.

In addition, a third condition, in which the first actuator 10 and the second actuator 11 are at least partially open, can be achieved, for example at a rotational angle of around 170 degrees.

Within this third condition, in which the actuators 10, 11 are at least partially open, it is possible to carry out a control in such way that the first actuator 10 is controlled to close from its at least partially opened condition, while at the same time the second actuator 11 is controlled to open further from its at least partially opened condition, or vice versa. This variant is possible, for example, in the region between point B and a rotational angle of around 190 degrees. With it, it is determined by the rotating direction of the shaft 7 and thus by the rotating or moving direction of the control device parts 5, 6, which of the first actuator 10 or the second actuator 11 will be further opened or closed.

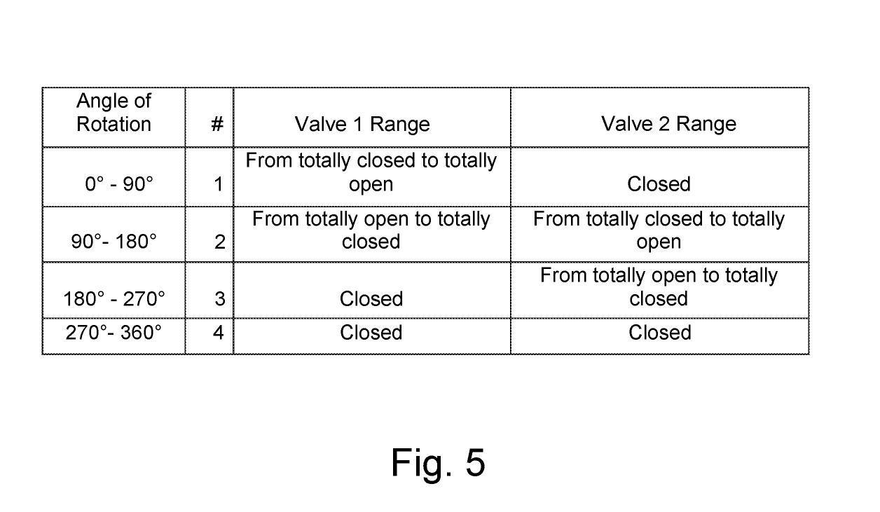

FIG. 5 shows a tabular listing of the conditions of the actuators according to FIGS. 3A to 3C. Four rotation angle ranges are shown, each of which covers a range of 90 degrees (90°). In addition, the table briefly describes the conditions or behaviours of the first and second valves 10, 11, which have already been explained in detail in the description in reference to FIGS. 3A-3C and 4.

By way of example, this tabular listing shows that in a rotational angle range from 0° to 90°, the first valve 10 is moved from its initial position, in which the valve 10 is completely closed, to a position in which the valve 10 is completely open, whereas in a rotational angle range from 0° to 90° the second valve 11 remains completely closed. The rotational angles that are listed in the table refer only to a specific embodiment of the invention and can be adjusted to other requirements or areas of use.

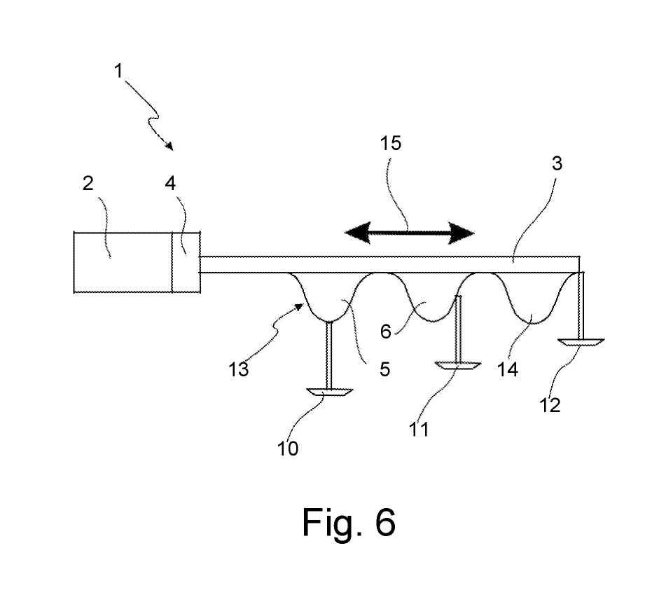

FIG. 6 shows second example of an assembly 1 according to the invention for operating actuators. FIG. 6 shows an already known drive system 2, which can be connected to a gear unit 4. The gear unit 4 is designed to enable a linear movement of the control device 3 within the adjustment field 15. Alternatively, the drive system 2 may be a linear drive system and may enable this linear movement of the control device 3 without a gear unit 4.

Alongside the control device 3, a plurality of control device parts 5, 6, 14 are positioned side by side in the form of a cam track 13. In another variant, a cam track comprising a single continuous piece may be utilized as well. In this case the control device parts 5, 6, 14 are formed by sections on the cam track 13. A first section of the cam track 13 thus forms the first control device part 5, for example, while a second section that follows the first section forms the second control device part 6, etc.

With a suitable design of the surface profile of the cam track 13, i.e. the control device parts 5, 6, 14, it is possible to control the displayed valves 10, 11, 12 as needed. In the example of FIG. 6, the first valve 10 is completely open at the illustrated position of the control device 3 within that of the adjustment region 15, while the second valve 11 is starting to open and the third valve 12 is completely closed. Through a change in the position of the control device 3 toward the right, it is possible to also completely open the valve 11 and then the valve 12.

The shaping of the control device parts 5, 6, 14 are illustrated as being virtually identical in FIG. 6, by way of example. Naturally, control device parts 5, 6, 14 may also take various forms, and can thereby be adapted to the respective control and regulation purpose to be fulfilled.

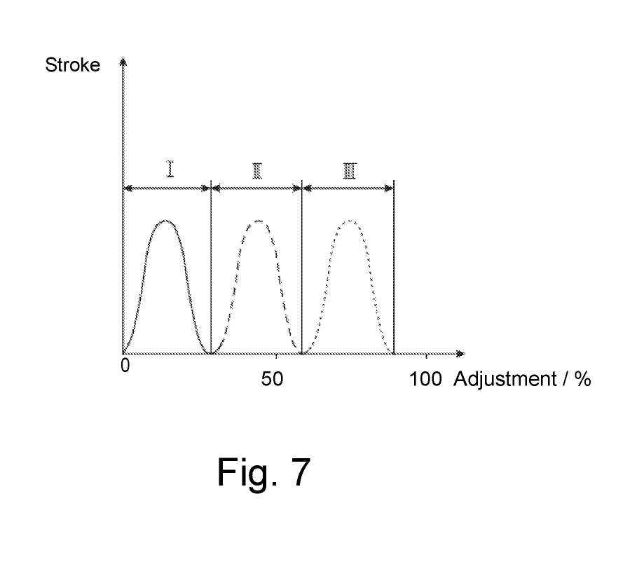

FIG. 7 shows a graphic illustration of the profile of the stroke functions of the actuators 10, 11, 12 of the assembly of FIG. 6, as a function of the deflection of the linear drive system within the adjustment region 15.

The stroke curve indicated by the bell curve in section I is assigned to the first actuator 10. The stroke curve indicated by the bell curve in section II is assigned to the second actuator 11, and the stroke curve indicated by the bell curve in section III is assigned to the third actuator 12.

As the graph shows, during a passage through the adjustment region 15, starting from 0% in the direction of the maximum adjustment of 100%, first the first valve 10 is opened while the valves 11, 12 remain closed. According to the stroke curve shown in the section I, the first valve 10 in the adjustment region of 0% is completely closed. At the adjustment increases, the valve 10 begins to open; it is completely open at the center of the section I and begins to close again afterward, until it is completely closed again at the end of the first section I.

In the subsequent, second section II, the above described process of opening and closing is repeated during passage through the corresponding adjustment region 15 for the second valve 11. In this section II, the second valve 11 reaches the condition in which it is completely open, while the second valve 10 and the third valve 12 remain completely closed.

At the center region of the third section III, the third valve 12 is then completely open, while the first valve 10 and the second valve 11 remain closed.

A person skilled in the art can change the timings and/or the opening widths of the valves 10, 11, 12 correspondingly, for example, by changing the cam track 13 or by shifting the control device parts 5, 6, 14 on the control device 3, and can thereby adjust to the existing controlling or regulation task. The number of valves and/or shutters to be controlled with a single drive system 2 is not limited to two or three. It is also possible to actuate one or more valves and one or more shutters simultaneously or independently of one another using a single drive system 2.

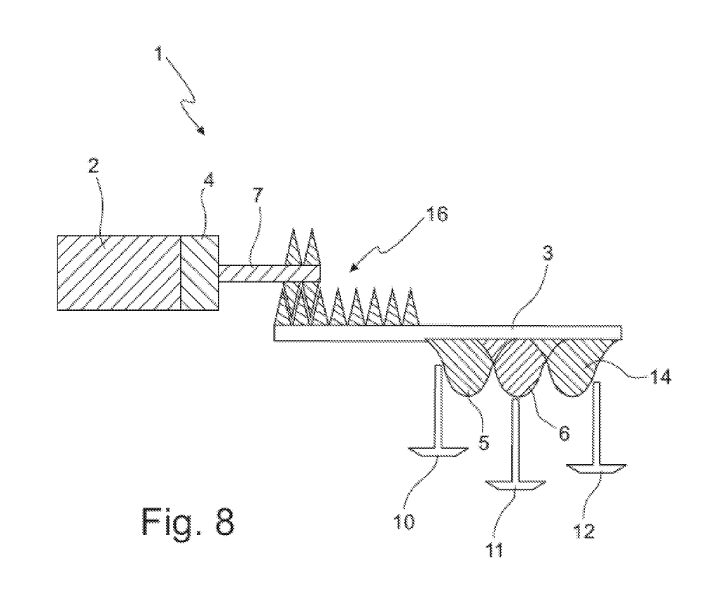

FIG. 8 shows a further embodiment of an assembly 1 according to the invention for operating an actuator 10.

The embodiment comprises the already known component assemblies of drive system 2, gear unit 4, shaft 7 and a control device 3 that is moveable in a longitudinal direction. In contrast to the embodiment of FIG. 6, the longitudinal movement of the control device 3 within the adjustment region 15 is achieved not by means of the gear unit 4 but by the deployment of a worm drive 16. In this embodiment as well, a plurality of control device parts 5, 6, 14 are positioned along the control device 3. Alternatively, the control device parts 5, 6, 14 may also be in the form of a cam track 13, not shown. The control of the valves 10, 11, 12 by means of the control device parts 5, 6, 14 corresponds to the method described in reference to FIG. 7. In FIG. 8, a condition is shown, in which, as compared with the section II of FIG. 7, the stroke of the second valve 11 is at its maximum. In this condition, the second valve 11 is open and the valves 10, 12 are closed.

FIG. 8 shows a further possible alternative for the present invention. There is no limitation to either of the described embodiments, since additional possibilities for converting an input side control variable of an actuator to a mechanical movement of multiple control device parts 5, 6, 14, and thus for operating a plurality of actuators 10, 11, 12, are known to a person skilled in the art.

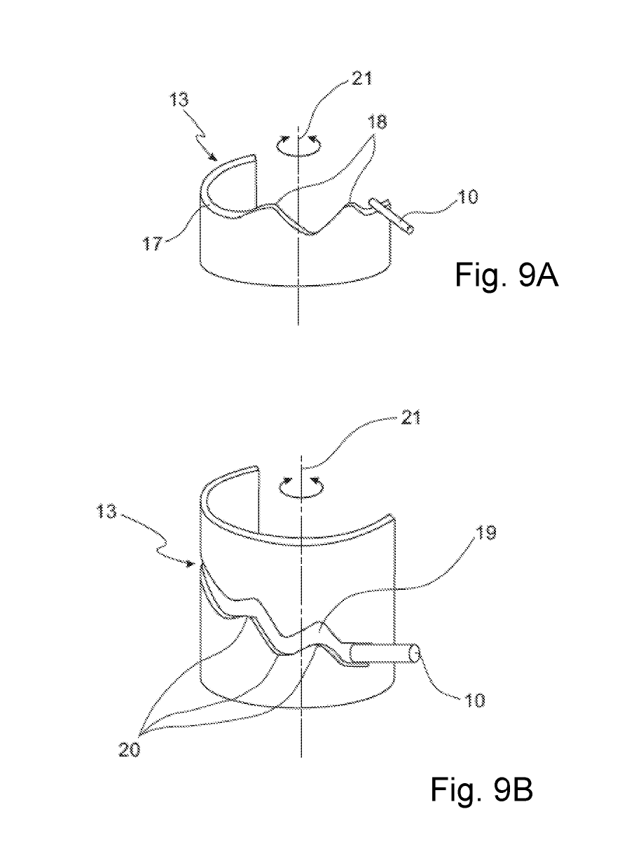

In FIGS. 9A and 9B, two embodiments of a control device 3 having a plurality of control device parts as components of a cam track 13 are illustrated in two variants.

In the FIG. 9A, a cam track 13 is shown, which extends along a circular track 17. The circular track 17 may extend along a part of the periphery of a circle, as shown in FIG. 9A by way of example.

It is foreseen that the circular track 17 has a plurality of elevations 18, each of these elevations being assigned to a control device part. For instance, the first elevation 18 may be assigned to a first control device part 5 and the second elevation 18 may be assigned to a second control device part 6. It is also foreseen that the control device 3 is moved around a rotational axis 21 by means of a drive system 2, not shown. With this rotational movement, indicated by the double arrow, the first actuator 10 shown in the example is adjusted in terms of its horizontal position, thereby actuating a valve 10 or a shutter 10. A second actuator 11, which is not shown in FIG. 9A, could be positioned at any optional angle, for example of 30°, 45°, 90° or 180°, relative to the first actuator 10. Thus at least two actuators 10, 11 are controlled by rotating the control device 3 around the rotational axis 21. The degree figures for the angle specified in the description are not intended as a restriction, and may be adjusted as needed according to requirements.

In an alternative embodiment, the cam track 13 for operation of the actuators 10, 11, 12 may also be formed by a slot 19 in the control device 3. A slot of this type may have a longitudinal extension or may extend in a circular shape, as shown in FIG. 9B. The slot 19 has a plurality of deflections 20, which form a plurality of control device parts 5, 6. When the control device 3 is rotated around the rotational axis 21, the position of the first actuator 10 shown is adjusted horizontally along the slot 19, thereby actuating a valve 10 or a shutter 10. In this embodiment, it is also foreseen to position at least a second actuator 11 offset by an angle relative to the first actuator 10, allowing at least two actuators 10, 11 to be operated simultaneously.

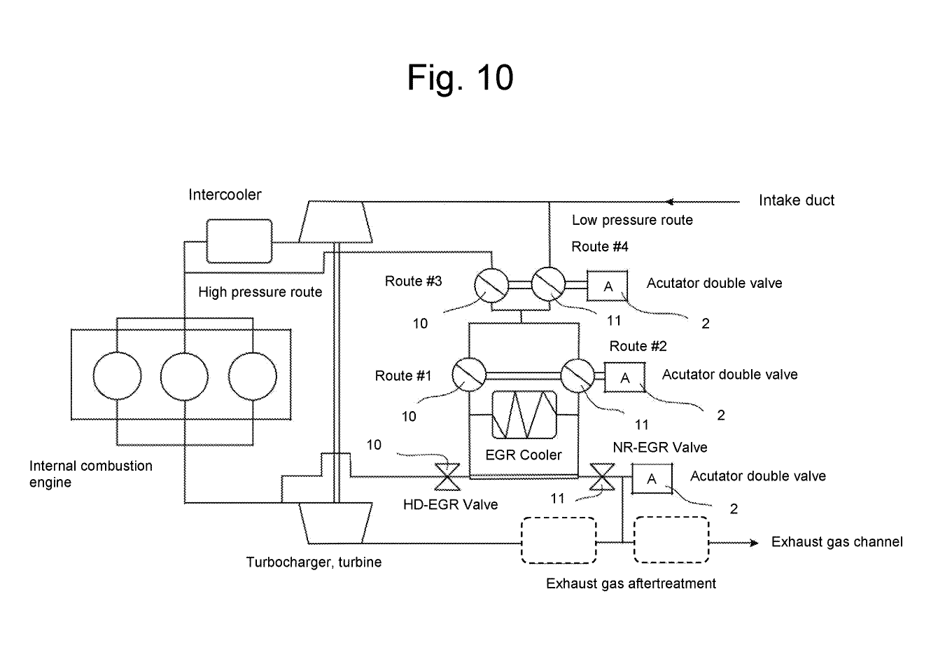

FIG. 10 is a schematic illustration of an internal combustion engine including the regions of air treatment, exhaust gas aftertreatment, and low pressure and high pressure regions of exhaust gas recirculation. In FIG. 10, the utilization of the present invention is demonstrated exemplarily in three different locations. In each case, the drive system 2 of an assembly 1 according to the invention for operating a plurality of actuators is illustrated with a first actuator 10 and a second actuator 11, which are controlled by the first and second control device parts 4, 5 that are controlled by the drive system 2.

As illustrated in the example, the number of the required drive systems can be reduced by half, that is to say, from six drive systems for controlling the six valves according to the prior art to three drive systems. With that come significant savings in terms of costs, required installation space and weight for the assemblies for operating actuators.

### LIST OF REFERENCE SIGNS

1 Assembly for operating actuators
2 Drive system/motor/actuator
3 Control device
4 Gear unit
5 First control device part/cam disc/cam
6 Second control device part/cam disc/cam
7 Shaft
8 first redirection device
9 second redirection device
10 first actuator/valve
11 second actuator/valve
12 third actuator/valve
13 Cam track
14 third control device part/cam disc/cam
15 adjustment range
16 Worm drive
17 Circular track
18 Elevation
19 slot
20 Deflection
21 Rotational axis

What is claimed is:

1. An assembly for operating actuators, the assembly comprising:
a drive system for driving a control device connected to the drive system, the control device connected at least indirectly to an actuator,
wherein the control device further comprises:
at least a first control device part; and
a second control device part, wherein the first control device part is connected at least indirectly to a first actuator and the second control device part is connected at least indirectly to a second actuator.

2. The assembly according to claim 1, wherein a first cam disc is provided for the first control device part and a second cam disc is provided for the second control device part.

3. The assembly according to claim 1, wherein a cam track having at least two sections is provided for the first control device part and the second control device part.

4. The assembly according to claim 3, wherein the cam track is linearly extending, a circular track, or a slot having at least two elevations or deflections.

5. The assembly according to claim 1, wherein the first actuator and the second actuator are a valve or a shutter.

6. The assembly according to claim 1, further comprising a gear unit and a shaft positioned between the drive system and the first control device part and the second control device part.

7. The assembly according to claim 1, further comprising a redirection device positioned between the first control device part and the first actuator or the second control device part and the second actuator.

8. A method for operating actuators, the method comprising the steps of:
providing a control device connected to a drive system, the control device driven by the drive system,
providing the control device with a first control device part and a second control device part, wherein the first control device part controls a first actuator and the second control device part controls a second actuator simultaneously, and wherein control is accomplished wherein at least a first condition, in which the first actuator and the second actuator are closed simultaneously, and a second condition, in which the first actuator is closed and the second actuator is opened or the first actuator is opened and the second actuator is closed, can be controlled.

9. The method according to claim 8, wherein the control is accomplished wherein a third condition, in which the first actuator and the second actuator are simultaneously at least partially opened, can be controlled.

10. The method according to claim 9, wherein the control within the third condition is accomplished wherein the first actuator is controlled to close from its at least partially opened condition while simultaneously, the second actuator is controlled to open further from its at least partially opened condition, or the second actuator is controlled to close from its at least partially opened condition while simultaneously, the first actuator is controlled to open further from its at least partially opened condition.
